(19) United States
(12) Patent Application Publication
(10) Pub. No.: US 2010/0262770 A1
(43) Pub. Date: Oct. 14, 2010

(54) Method for Enhancing Information Security in a Computer System

(76) Inventor: Wen-Chuan Chao, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 12/699,823

(22) Filed: Feb. 3, 2010

(30) Foreign Application Priority Data
Apr. 14, 2009 (TW) 098112303

(51) Int. Cl. G06F 12/14; G06F 12/00

(52) U.S. Cl. 711/112; 711/163; 726/16; 711/E12.001; 711/E12.091

(57) ABSTRACT

A method for enhancing information security in a computer system includes receiving a service serial number, encoding the service serial number according to an encoding rule, to generate a first hard-disk code, storing the first hard-disk code into a hard disk of the computer system to make the hard disk to be accessed by only the computer system.

### BACKGROUND OF THE INVENTION

1. Field of the Invention

The present invention is related to a method for enhancing information security in a computer system, and more particularly, to a method capable of enhancing information security without sacrificing convenience.

2. Description of the Prior Art

A hard disk is one of the most important storage devices in a computer system. Various kinds of data, such as an operating system, application programs, multimedia files, etc., are stored in the hard disk. Thus, for most users, losing their hard disks is more troublesome than losing others. Once losing a hard disk, a user is not only afraid of loss of financial property but also disclosure of personal privacy. For example, somebody may steal personal mails, pictures, memos, diaries, etc., from the hard disk, even worse, which may lead to another property loss for the sake of blackmailing.

For preventing those problems, the prior art provides a function for encrypting the hard disk, in which a hard-disk code is set up by the user, and is stored in the hard disk. When the computer system is powered on, the user has to input the correct hard-disk code to access the hard disk. In such a situation, even though the hard disk is stolen or missing, data within the hard disk is safe as long as the hard-disk code is not cracked. However, the aforementioned function works only if the user activates the function and sets up the hard-disk code. Meanwhile, the user has to re-input the hard-disk code for verification as the computer system is powered on. Obviously, this kind of procedure is inconvenient to the user.

For these reasons, preventing the theft-derivative problems without sacrificing convenience has been one of the objectives the industry is focusing on.

### SUMMARY OF THE INVENTION

It is therefore a primary objective of the claimed invention to provide a method for enhancing information security in a computer system.

The present invention discloses a method for enhancing information security in a computer system. The method comprises acquiring a service serial number of the computer system, encoding the service serial number according to an encoding rule to generate a first hard-disk code, and storing the first hard-disk code into a hard disk of the computer system to make the hard disk to be accessed by only the computer system.

The present invention further discloses a method for enhancing information security in a computer system having a hard disk storing a first hard-disk code. The method comprises acquiring a service serial number of the computer system when the computer system is powered on, encoding the service serial number according to an encoding rule to generate a second hard-disk code to the hard disk, the hard disk comparing the first hard-disk code with the second hard-disk code to generate a first comparison result, and the hard disk determining whether to permit the computer system to access the hard disk according to the first comparison result.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a process according to an embodiment of the present invention.

FIG. 2 is a schematic diagram of a process according to an embodiment of the present invention.

### DETAILED DESCRIPTION

In order to upgrade quality of service, computer system manufacturers design an exclusive service serial number for each computer system to recognize a corresponding buyer or product information. For example, when defective components of the computer system are to be replaced, the manufacturer can acquire information of the corresponding buyer to send related status to the buyer. Therefore, the present invention can utilize this independent, exclusive service serial number and the existing protection schemes to achieve an objective of enhancing information security.

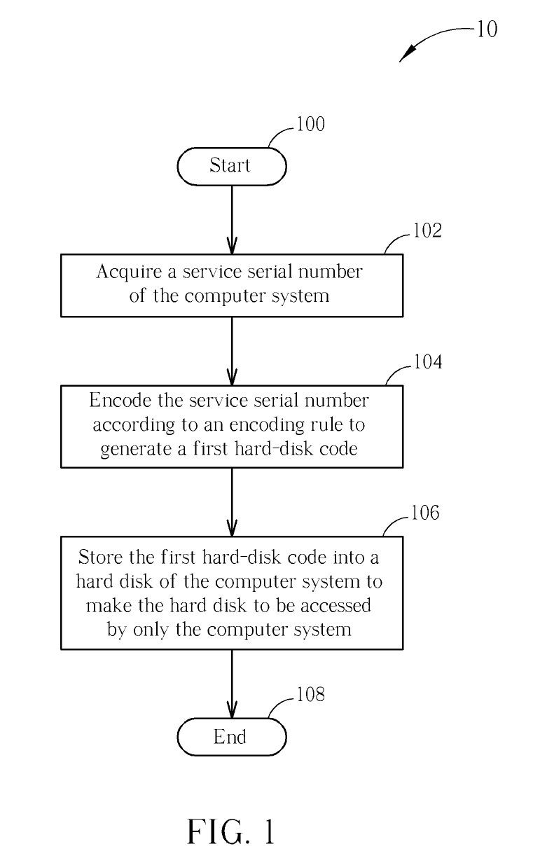

Please refer to FIG. 1, which is a schematic diagram of a process 10 according to an embodiment of the present invention. Utilized in a computer system, the process 10 comprises the following steps:

Step 100: Start.

Step 102: Acquire a service serial number of the computer system.

Step 104: Encode the service serial number according to an encoding rule to generate a first hard-disk code.

Step 106: Store the first hard-disk code into a hard disk of the computer system to make the hard disk to be accessed by only the computer system.

Step 108: End.

According to the process 10, the present invention encodes the exclusive service serial number based upon the default encoding rule to generate the hard-disk code and store the hard-disk code in the hard disk, so as to make the hard disk to be accessed by only the computer system. As a result, the user can boot the computer system without inputting the hard-disk code. In other words, the present invention takes both information security and convenience into consideration.

In short, the present invention utilizes existing password authentication schemes under an auto-generated “password”—the hard-disk code generated according to the service serial number. In the present invention, since the service serial number of each computer system is independent and exclusive, an identical hard-disk code can be twice generated only if the hard-disk code is corresponding to the same computer system whenever the hard-disk code is generated. In such a situation, the user can reach same protective effect without setting up the hard-disk code on purpose. That is, in the present invention, even if the hard disk is stolen and linked to another computer system, nobody can access the hard disk through the new-linked computer system since the service serial number only belongs to the original computer system. As a result, information security can be accordingly enhanced without sacrificing convenience.

In the prior art, when activating the function for encrypting the hard disk, the user has to set up the hard-disk code and re-input the hard-disk code for verification once the computer system is powered on. In comparison, in the present invention, the hard-disk code is not generated by the user but automatically generated by the computer system according to the service serial number. Meanwhile, instead of inputting the hard-disk code manually, the computer system generates exactly the same hard-disk code in the same logic for verification when the computer system is powered on. Thus, for the user, no extra inputting the hard-disk code behavior, no problems arising from theft.

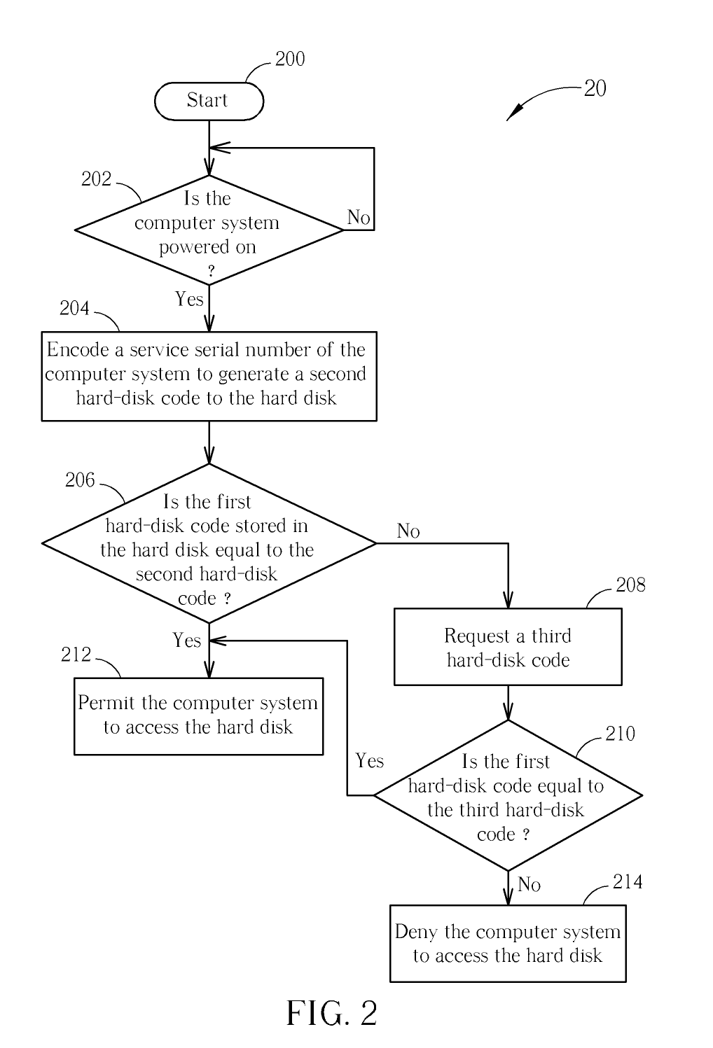

Note that, the process 10 in FIG. 1 illustrates an embodiment of the present invention. Certainly, those skilled in the art can make modification and variation accordingly. For example, except that the computer system automatically generates the hard-disk code according to the service serial number, the user can manually generate the hard-disk code. In this case, the process 10 can be extended into a process 20, as illustrated in FIG. 2. The process 20 is utilized for enhancing information security in a computer system having a hard disk storing a first hard-disk code, and comprises the following steps:

Step 200: Start.

Step 202: Determine whether the computer system is powered on. If yes, proceed to Step 204.

Step 204: Encode a service serial number of the computer system according to an encoding rule, to generate a second hard-disk code to the hard disk.

Step 206: The hard disk verifies whether the first hard-disk code is equal to the second hard-disk code. If yes, proceed to Step 212; else, proceed to Step 208.

Step 208: Request a third hard-disk code.

Step 210: The hard disk verifies whether the first hard-disk code is equal to the third hard-disk code. If yes, proceed to Step 212; else, proceed to Step 214.

Step 212: The hard disk permits the computer system to access the hard disk.

Step 214: The hard disk denies the computer system to access the hard disk.

According to the process 20, when the computer system is powered on, the present invention encodes the service serial number based upon the default encoding rule, to generate the corresponding second hard-disk code to the hard disk. If the second hard-disk code is equal to the first hard-disk code stored in the hard disk, indicating that the computer system generates the first hard-disk code with the original logic (the process 10), and the hard disk is not stolen, the present invention determines that the hard disk is accessible to the computer system. Inversely, if the second hard-disk code is not equal to the first hard-disk code, indicating that the second hard-disk code maybe set up by the user, or the hard disk is stolen, the computer system would request the user to input the third hard-disk code. If the third hard-disk code is equal to the first hard-disk code, indicating that the first hard-disk code is setup by the user, and the user is licensed, the present invention determines that the hard disk is accessible to the computer system. Inversely, if the third hard-disk code is not equal to the first hard-disk code, indicating that the hard disk is stolen, the present invention determines that the hard disk is inaccessible to the computer system.

In short, when the user does not manually set up the hard-disk code, the present invention can automatically protect the hard disk via the service serial number. On the contrary, when the user manually sets up the hard disk code, the present invention would request the user to input the correct hard disk code, which is exactly the same as the prior art.

Certainly, in addition to the aforementioned embodiments, those skilled in the art can accordingly make modification and variation. For example, when moving the hard disk to other computer systems, the user can manually set up the hard-disk code or disable the function of encryption for further use.

In addition, the present invention can preferably implement the processes 10 and 20 by software or firmware. Nevertheless, implementations thereof are not key points of the present invention, and not given herein.

To sum up, the present invention enhances information security through the service serial number, exclusive to each computer system, and existing protection schemes. Therefore, the present invention can prevent those theft-derivative problems without changing current hard disk implementation method, pre-setting up any hard-disk code, and requesting for inputting the password, so as to enhance information security without sacrificing convenience.

Those skilled in the art will readily observe that numerous modifications and alterations of the device and method may be made while retaining the teachings of the invention.

What is claimed is:

1. A method for enhancing information security in a computer system comprising:
acquiring a service serial number of the computer system;
encoding the service serial number according to an encoding rule, to generate a first hard-disk code; and
storing the first hard-disk code into a hard disk of the computer system, to make the hard disk to be accessed by only the computer system.

2. The method of claim 1, wherein the step of making the hard disk to be accessed by only the computer system comprises:
encoding the service serial number according to the encoding rule when the computer system is powered on, to generate a second hard-disk code to the hard disk; and
permitting the hard disk to be accessed by the computer system when the hard disk determines that the first hard-disk code is equal to the second hard-disk code.

3. The method of claim 1, wherein the service serial number is exclusive to the computer system.

4. A method for enhancing information security in a computer system having a hard disk storing a first hard-disk code comprising:
acquiring a service serial number of the computer system when the computer system is powered on;
encoding the service serial number according to an encoding rule, to generate a second hard-disk code to the hard disk;
the hard disk comparing the first hard-disk code with the second hard-disk code, to generate a first comparison result; and
the hard disk determining whether to permit the computer system to access the hard disk according to the first comparison result.

5. The method of claim 4, wherein the step of the hard disk determining whether to permit the computer system to access the hard disk according to the first comparison result is the hard disk permitting the computer system to access the hard disk when the first comparison result indicates that the first hard-disk code is equal to the second hard-disk code.

6. The method of claim 4, wherein the step of the hard disk determining whether to permit the computer system to access the hard disk according to the first comparison result is the hard disk denying the computer system to access the hard disk when the first comparison result indicates that the first hard-disk code is not equal to the second hard-disk code.

7. The method of claim 6 further comprising:
receiving a third hard-disk code;
the hard disk comparing the first hard-disk code with the third hard-disk code, to generate a second comparison result; and
the hard disk determining whether to permit the computer system to access the hard disk according to the second comparison result.

8. The method of claim 7, wherein the step of the hard disk determining whether to permit the computer system to access the hard disk according to the second comparison result is the hard disk permitting the computer system to access the hard disk when the second comparison result indicates that the first hard-disk code is equal to the third hard-disk code.

9. The method of claim 7, wherein the step of the hard disk determining whether to permit the computer system to access the hard disk according to the second comparison result is the hard disk denying the computer system to access the hard disk when the first comparison result indicates that the first hard-disk code is not equal to the third hard-disk code.

10. The method of claim 4, wherein the service serial number is exclusive to the computer system.
